(19) United States
(12) Patent Application Publication
(10) Pub. No.: US 2013/0147812 A1
(43) Pub. Date: Jun. 13, 2013

(54) HEATING, VENTILATION AND AIR CONDITIONING SYSTEM USER INTERFACE HAVING PROPORTIONAL ANIMATION GRAPHICS AND METHOD OF OPERATION THEREOF

(71) Applicants: Larry S. Bias, Prosper, TX (US); Daniel Castillo, Plano, TX (US); Bobby DiFulgentiz, Frisco, TX (US); Gabaza B. Mlambo, McKinney, TX (US); Stephen J. Vendt, Little Elm, TX (US)

(72) Inventors: Larry S. Bias, Prosper, TX (US); Daniel Castillo, Plano, TX (US); Bobby DiFulgentiz, Frisco, TX (US); Gabaza B. Mlambo, McKinney, TX (US); Stephen J. Vendt, Little Elm, TX (US)

(73) Assignee: Lennox Industries Inc., Richardson, TX (US)

(21) Appl. No.: 13/432,826

(22) Filed: Mar. 28, 2012

Related U.S. Application Data
(60) Provisional application No. 61/569,859, filed on Dec. 13, 2011.

(51) Int. Cl. G06F 3/041; G06T 13/00

(52) U.S. Cl. 345/473

(57) ABSTRACT

A user interface for use with an HVAC system, a method of providing service reminders on a single screen of a user interface of an HVAC system and an HVAC system incorporating the user interface or the method. In one embodiment, the user interface includes: (1) a display configured to provide information to a user, (2) a touchpad configured to accept input from the user and (3) a processor and memory coupled to the display and the touchpad and configured to drive the display, the display further configured to display proportional animation graphics corresponding to attributes of the HVAC system.

### CROSS-REFERENCE TO RELATED APPLICATION

This application claims the benefit of U.S. Provisional Application Ser. No. 61/569,859, filed by Bias, et al., on Dec. 13, 2011, entitled “Heating, Ventilation and Air Conditioning System User Interface Having One or More of One-Touch Away Feature, Adjustable Fonts, Proportional Animation Graphics, Service Reminders on a Single Screen, Separate Programming and Manual Mode Screens, Integrated Screen/Housing Skin, Low-Profile Housing, Secure Functional Upgrade Feature and Remote Platform Access Application Associated Therewith,” commonly assigned with this application and incorporated herein by reference.

### TECHNICAL FIELD

This application is directed, in general, to a heating, ventilation and air conditioning (HVAC) systems and, more specifically, to an HVAC system having a user interface, such as a thermostat.

### BACKGROUND

Users interact with HVAC systems through user interfaces. The most common user interface employed today is the thermostat. The most basic thermostats feature one or more dials, switches or levers and allow users to set temperatures. More elaborate thermostats feature a liquid crystal display (LCD) screen, perhaps even of the touchscreen variety, and allow users to program their HVAC systems for automatic temperature settings, configure and maintain their HVAC systems and records of historical operation data, allowing the users to gauge the performance and efficiency of their HVAC systems.

Thermostats necessarily include both temperature sensors and control circuitry within their housings. Some user interfaces do not qualify as thermostats, because while they communicate with temperature sensors and control circuitry, they do not include both within their housings.

### SUMMARY

One aspect provides a user interface. In one embodiment, the user interface includes: (1) a display configured to provide information to a user, (2) a touchpad configured to accept input from the user and (3) a processor and memory coupled to the display and the touchpad and configured to drive the display, the display further configured to display proportional animation graphics corresponding to attributes of the HVAC system.

Another aspect provides a method of providing service reminders on a single screen of a user interface of an HVAC system. In one embodiment, the method includes: (1) providing information to a user with a display, (2) accepting input from the user with a touchpad and (3) displaying proportional animation graphics corresponding to attributes of the HVAC system.

Yet another aspect provides an HVAC system. In one embodiment, the HVAC system includes: (1) a heat pump or a compressor having at least one stage, (2) at least one condenser coil, (3) an expansion valve, (4) at least one evaporator coil, (5) a loop of pipe interconnecting the heat pump or compressor, the at least one condenser coil, the expansion valve and the at least one evaporator coil and containing a refrigerant, (6) at least one fan configured to cause outdoor air and indoor air to blow over the at least one condenser coil and the least one evaporator coil and (7) a user interface, including: (7a) a display configured to provide information to a user, (7b) a touchpad configured to accept input from the user and (7c) a processor and memory coupled to the display and the touchpad and configured to drive the display, the display further configured to display proportional animation graphics corresponding to attributes of the HVAC system.

### BRIEF DESCRIPTION

Reference is now made to the following descriptions taken in conjunction with the accompanying drawings, in which:

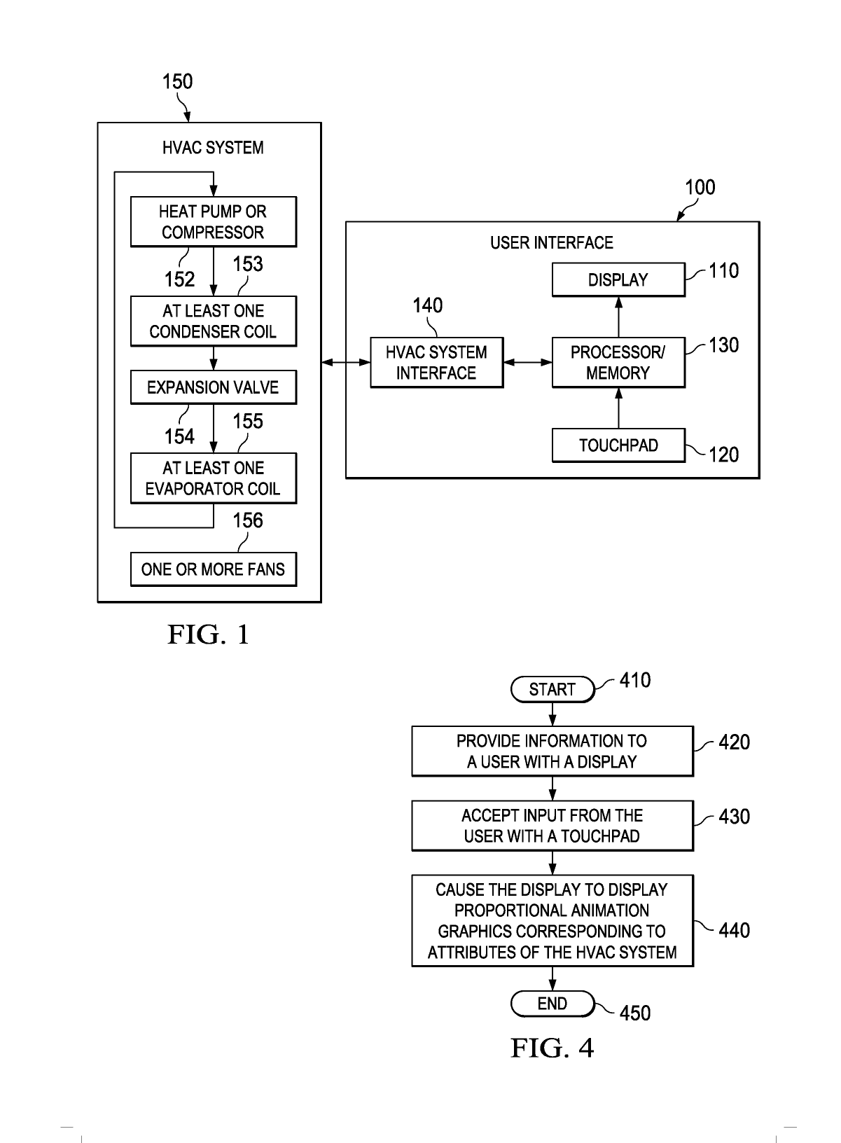

FIG. 1 is a block diagram of one embodiment of a user interface;

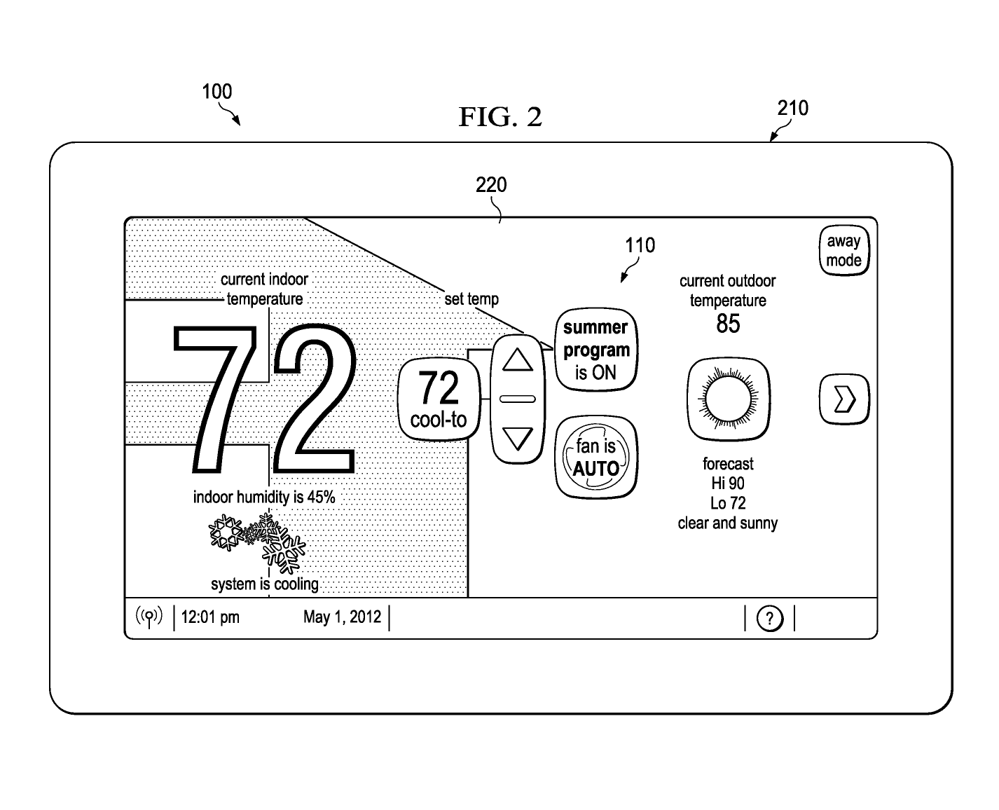

FIG. 2 is a front-side elevational view of one embodiment of a user interface;

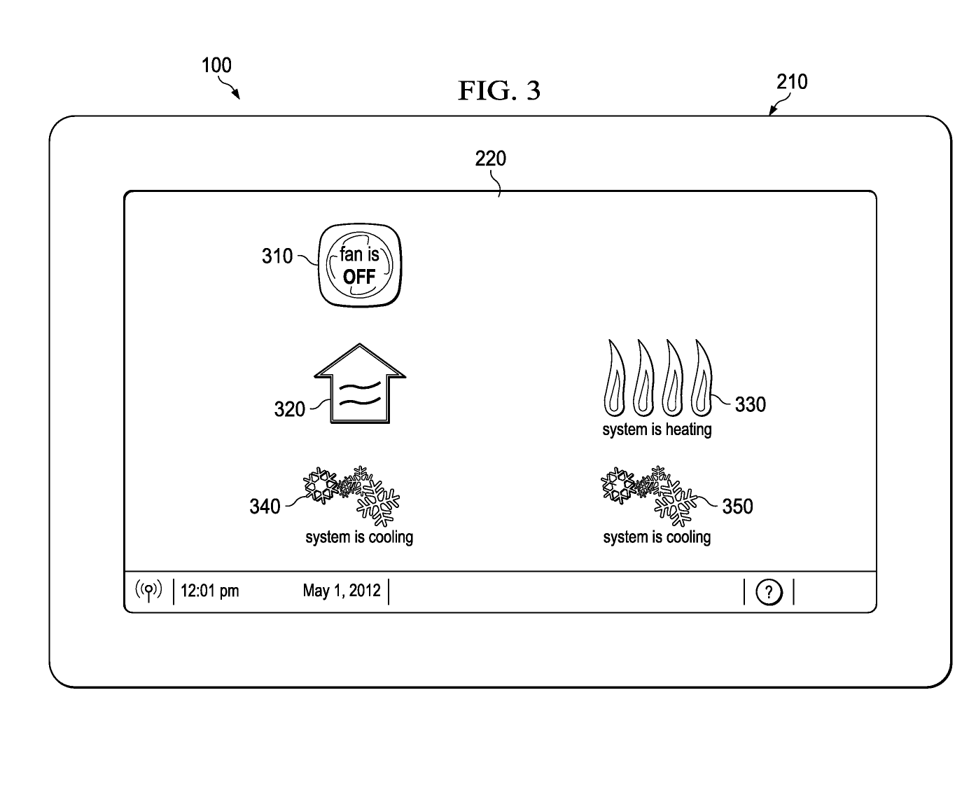

FIG. 3 is a representation of one embodiment of a screen of the user interface of FIG. 2 having one embodiment of proportional animation graphics; and

FIG. 4 is a flow diagram of one embodiment of a method of providing proportional animation graphics on a user interface of an HVAC system.

### DETAILED DESCRIPTION

FIG. 1 is a block diagram of one embodiment of a user interface 100. The interface has a display 110 and a touchpad 120. The display 110 is configured to provide information to a user, and the touchpad 120 is configured to accept input from a user. A processor and memory 130 are coupled to the display 110 and the touchpad 120 to drive the display 110 and process the input from the touchpad 120. More accurately, software or firmware is loaded into and stored in the memory and, when executed in the processor, configures the processor to drive the display 110 and process the input from the touchpad 120. An HVAC system interface 140 is coupled to the processor and memory 130 and is configured to provide communication between the processor and memory 130 and the remainder of an HVAC system 150. In various embodiments, the HVAC system 150 includes one or more loops of pipe (one being shown and referenced as 151) containing a refrigerant. Each loop transports the refrigerant among a heat pump or a compressor 152 having at least one stage, at least one condenser coil 153, an expansion valve 154 and at least one evaporator coil 155. One or more fans (“blowers”) 156 cause outdoor air and indoor air to blow over the at least one condenser coil 153 and the at least one evaporator coil 155 to transfer heat to or from them. Those skilled in the pertinent art are familiar with conventional HVAC systems and generally understand the many embodiments and forms they may take.

FIG. 2 is a front-side elevational view of one embodiment of the user interface of FIG. 1. The user interface 100 has a bezel 210. The display 110 is configured to display at least one screen 220 of information for the benefit of a user (the term also including an installer or any other person interested in gaining information from the user interface 100).

Although unreferenced, the screen 220 shown in FIG. 2 includes a current temperature display portion, a setpoint temperature display portion, buttons to raise or lower the setpoint temperature, a system mode message display portion (i.e., “system is heating”) and a program status message display portion (i.e., “program is on”). The screen 220 also has current date and time display portions and allows the user to display other screens (via a “press for more” message).

FIG. 3 is a representation of one embodiment of a screen of the user interface of FIG. 2 having one embodiment of proportional animation graphics. Proportional animation graphics are one or more images (graphics) that either or both of: (1) move (are animated) or (2) contain some graphical element that varies in terms of size, number or both size and number to indicate a magnitude of an attribute that the graphics represents (i.e., are proportional to the attribute). Proportional animation graphics provides a relatively accurate and intuitive representation of the equipment operation to a user. In various embodiments, the proportional animation graphics are located in various areas of the screen or the entirety of the background of the screen. Those skilled in the pertinent art will understand that the scope of the invention imposes no limits on the size, number or location of proportional animation graphics.

As newer HVAC systems allow for higher granularity in operation control, users are typically uninformed with regard to details of equipment operation. For instance, current user interfaces do not provide a way to track of understand: furnace or air handler blower CFM (variable airflow); auxiliary/emergency heat (on/off); heating stage (modulating or stage information); or cooling (compressor) capacity.

An easy to read graphical and proportional representation of some of these parameters individually or as a group would be very valuable for users:

a. They would facilitate understanding of equipment parameters.

b. They would provide a visible way to know the “higher end” or “advanced” features that were promised during equipment sale and installation are functioning (and to what “level”).

c. They would provide users with additional information about equipment loading or capacity which can be used as collateral information to take action on HVAC parameters to impact energy usage.

Examples of proportional animation graphics are as follows:

Fan. A fan graphic would depict whether the air handler or furnace is running or not. Fan blades on the fan graphic would spin faster depending on the amount of air flow (expressed in cubic feet per minute, or CFM) that the blower is delivering at a particular point in time. The CFM depends on blower RPM, torque and static pressure in the supply ducts. The apparent fan RPM is a function of the percentage of CFM being delivered. 100% (and maximum fan rate, expressed in revolutions per minute, or RPM) would be the maximum CFM allowed for the particular application. The maximum fan RPM could be adjusted for ideal viewing.

Cooling/Heating. Cooling and heating graphic elements would both show an animation based on equipment operation. The animation would proportionally reflect the amount of heating or cooling that is being currently applied to the space. Heating stage or percentage of demand for heating and stage or percentage of compressor cooling capacity for cooling. For heating, the number of flames could increase or decrease. For cooling, the number of snowflakes could increase or decrease.

FIG. 3 illustrates some examples. For example, a blower fan may be off (represented by a proportional animation graphic 310). The HVAC system may be in an auxiliary or emergency heating mode (represented by a proportional animation graphic 320). The HVAC system may be in a normal heating mode (represented by a proportional animation graphic 330), the number of flames representing the number of heating stages that are currently active. The HVAC system may be in a normal cooling mode (represented by a proportional animation graphics 340, 350), the number of snowflakes representing the number of cooling stages that are currently active. Note that the graphic 340 has fewer snowflakes than the graphic 350.

FIG. 4 is a flow diagram of one embodiment of a method of providing proportional animation graphics on a user interface of an HVAC system. The method begins in a start step 410. In a step 420, information is provided to a user with a display. In a step 430, input from the user is accepted with a touchpad. In a step 440, the display is caused to display proportional animation graphics corresponding to attributes of the HVAC system. The method ends in an end step 450.

Those skilled in the art to which this application relates will appreciate that other and further additions, deletions, substitutions and modifications may be made to the described embodiments.

1. A user interface for use with an HVAC system, comprising:
a display configured to provide information to a user;
and
a processor and memory coupled to said display and configured to drive said display, said display further configured to display proportional animation graphics corresponding to attributes of said HVAC system.

2. The user interface as recited in claim 1 wherein said proportional animation graphics move to indicate a magnitude of an attribute that said proportional animation graphics represents.

3. The user interface as recited in claim 1 wherein said proportional animation graphics contain a graphical element that varies to indicate a magnitude of an attribute that said proportional animation graphics represents.

4. The user interface as recited in claim 3 wherein said graphical element varies in terms of size.

5. The user interface as recited in claim 3 wherein said graphical element varies in terms of number.

6. The user interface as recited in claim 1 wherein said proportional animation graphics include a fan graphic element having fan blades that spin based on a rate of air flow a blower is delivering at a particular point in time.

7. The user interface as recited in claim 1 wherein said proportional animation graphics include a heating graphic element having a number of flames that varies based on a percentage of heating demand.

8. The user interface as recited in claim 1 wherein said proportional animation graphics include a cooling graphic element having a number of snowflakes that varies based on a percentage of compressor cooling capacity.

9. A method of providing proportional animation graphics on a user interface of an HVAC system, comprising:
providing information to a user with a display;
accepting input from said user; and
displaying proportional animation graphics corresponding to attributes of said HVAC system.

10. The method as recited in claim 9 wherein said proportional animation graphics move to indicate a magnitude of an attribute that said proportional animation graphics represents.

11. The method as recited in claim 9 wherein said proportional animation graphics contain a graphical element that varies to indicate a magnitude of an attribute that said proportional animation graphics represents.

12. The method as recited in claim 11 wherein said graphical element varies in terms of size.

13. The method as recited in claim 11 wherein said graphical element varies in terms of number.

14. The method as recited in claim 9 wherein said proportional animation graphics include a fan graphic element having fan blades that spin based on a rate of air flow a blower is delivering at a particular point in time.

15. The method as recited in claim 9 wherein said proportional animation graphics include a heating graphic element having a number of flames that varies based on a percentage of heating demand.

16. The method as recited in claim 9 wherein said proportional animation graphics include a cooling graphic element having a number of snowflakes that varies based on a percentage of compressor cooling capacity.

17. An HVAC system, comprising:
a heat pump or a compressor having at least one stage;
at least one condenser coil;
an expansion valve;
at least one evaporator coil;
a loop of pipe interconnecting said heat pump or compressor, said at least one condenser coil, said expansion valve and said at least one evaporator coil and containing a refrigerant;
at least one fan configured to cause outdoor air and indoor air to blow over said at least one condenser coil and said least one evaporator coil; and
a user interface, including:
a display configured to provide information to a user,
a touchpad configured to accept input from said user, and
a processor and memory coupled to said display and said touchpad and configured to drive said display, said display further configured to display proportional animation graphics corresponding to attributes of said HVAC system.

18. The user interface as recited in claim 17 wherein said proportional animation graphics move to indicate a magnitude of an attribute that said proportional animation graphics represents.

19. The user interface as recited in claim 17 wherein said proportional animation graphics contain a graphical element that varies to indicate a magnitude of an attribute that said proportional animation graphics represents.

20. The user interface as recited in claim 19 wherein said graphical element varies in terms of size.

21. The user interface as recited in claim 19 wherein said graphical element varies in terms of number.
